(19) United States
(12) Patent Application Publication
(10) Pub. No.: US 2024/0283191 A1
(43) Pub. Date: Aug. 22, 2024

(54) CONNECTOR

(71) Applicant: YAZAKI CORPORATION, Tokyo (JP)

(72) Inventors: Seiji Kozono, Kakegawa-shi (JP); Yoshitaka Tsushima, Kakegawa-shi (JP)

(21) Appl. No.: 18/653,974

(22) Filed: May 3, 2024

Related U.S. Application Data
(63) Continuation of application No. PCT/JP2023/004864, filed on Feb. 13, 2023.

(30) Foreign Application Priority Data
Feb. 21, 2022 (JP) 2022-025076

(51) Int. Cl. H01R 13/514; H01R 12/72; H01R 13/52

(52) U.S. Cl. CPC H01R 13/514; H01R 12/724; H01R 13/5219

(57) ABSTRACT

A packing includes a first recess formed in a surface on one side in a central axis direction of an annular shape, and a second recess formed in a surface on the other side in the central axis direction. The cover to which the packing is to be attached includes a front cover and a rear cover that are separately provided to sandwich and hold the packing therebetween. The front cover has a first protrusion to be inserted into and held by the first recess, and the rear cover has a second protrusion to be inserted into and held by the second recess.

### CROSS-REFERENCE TO RELATED APPLICATIONS

This is a continuation of International Application No. PCT/JP2023/004864 filed on Feb. 13, 2023, and claims priority from Japanese Patent Application No. 2022-025076 filed on Feb. 21, 2022, the entire content of which is incorporated herein by reference.

### TECHNICAL FIELD

The present invention relates to a connector including a cover.

### BACKGROUND ART

In related art, wire harnesses (electric wires) that electrically connect various electric components mounted on an automobile or the like are connected by connectors. Such a connector generally includes a male connector and a female connector. For example, in a case of a connector structure applied to an optional specification, there is known a connector structure in which one connector connected to an end portion of an electric wire arranged in advance has a shutter mechanism at a front opening of a housing for a purpose of dust proofing, terminal protection, prevention of electric shock to the surroundings, and the like until the other connector is fitted thereto. Particularly in an electric automobile or the like, in order to prevent an electric shock accident or the like, a connector (inlet) with a shutter mechanism is applied to prevent exposure of a terminal at a front opening when the connector is not fitted. As an example of such a configuration, for example, there is a connector with a shutter mechanism disclosed in Patent Literature 1.

However, the connector with the shutter mechanism according to Patent Literature 1 has a structure in which a front opening of a housing is merely covered with a shutter. Therefore, there is a gap between the shutter and the connector, and dust, water, or the like may enter the connector.

A packing is generally used to seal such a gap. For example, in an example disclosed in Patent Literature 2, a packing is attached to a connector, and a gap between the connector and an accommodating box that accommodates the connector is sealed by the packing. However, Patent Literature 2 discloses a structure in which a groove that accommodates the packing is formed in an outer surface of the connector, and the packing is fitted into the groove. Therefore, when fitting the connector into the accommodating box, an assembly failure of the packing such as biting of the packing or coming-off of the packing may occur. Therefore, even when a technique of Patent Literature 2 is applied to Patent Literature 1, an assembly failure of the packing may occur similarly.

### CITATION LIST

### Patent Literature

Patent Literature 1: JPH08-138785A
Patent Literature 2: JP2020-048263A

### SUMMARY OF INVENTION

### Technical Problem

The present invention has been made in view of the above circumstances, and an object thereof is to provide a connector that prevents an assembly failure of a packing.

### Solution to Problem

In order to achieve the above object, a connector according to the present invention has the following features.

A connector includes:
a housing including an accommodating portion that accommodates a connection terminal and a tubular portion having an opening into which a mating connector is to be inserted;
a cover configured to cover the opening in an openable and closable manner; and
an annular packing configured to be attached to one of the cover and the housing and to seal a gap between the tubular portion and the cover at a closed position where the cover closes the opening, in which
the packing has a first recess formed in a surface on one side in a central axis direction of an annular shape, and a second recess formed in a surface on the other side in the central axis direction,
the one of the cover and the housing to which the packing is to be attached includes a first member and a second member that are separately provided to sandwich and hold the packing therebetween,
the first member includes a first protrusion to be inserted into and held by the first recess, and
the second member includes a second protrusion to be inserted into and held by the second recess.

### Advantageous Effects of Invention

According to the present invention, it is possible to provide the connector that prevents the assembly failure of the packing.

The present invention has been briefly described above. Further, details of the present invention can be clarified by reading modes (hereinafter, referred to as “embodiments”) for carrying out the invention to be described below with reference to the accompanying drawings.

### BRIEF DESCRIPTION OF DRAWINGS

FIG. 1 is a perspective view showing an embodiment of an inlet as a connector according to the present invention.

FIG. 2 is an exploded perspective view of the inlet shown in FIG. 1.

FIG. 3 is a partial cross-sectional exploded perspective view of a cover constituting the inlet shown in FIG. 1.

FIG. 4 is a partial cross-sectional view of the cover constituting the inlet shown in FIG. 1 when the cover is at a closed position.

FIG. 5 is a partial cross-sectional view of the inlet when the cover is at an open position.

FIG. 6 is a partial cross-sectional view of the inlet when the cover is at the closed position.

FIG. 7 is a partial enlarged view of FIG. 6.

FIG. 8 is a partial cross-sectional view of an inlet when a cover is at a closed position according to another embodiment.

### DESCRIPTION OF EMBODIMENTS

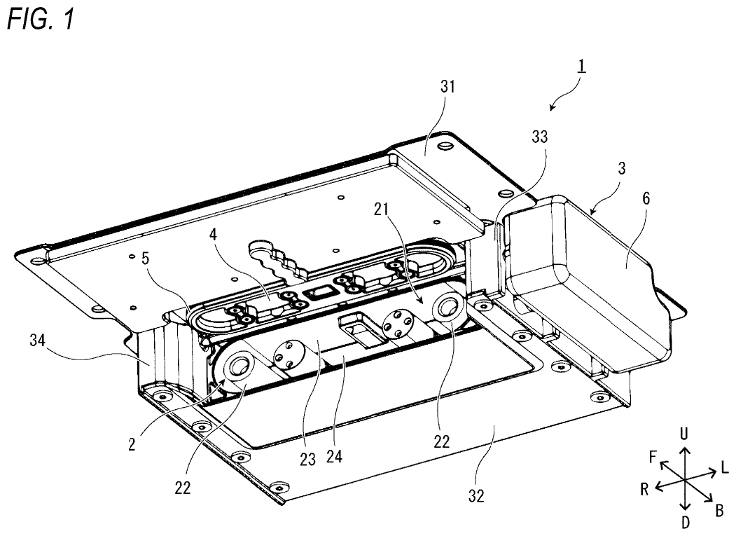

Specific embodiments of the present invention will be described below with reference to the drawings. Hereinafter, as shown in FIG. 1 and the like, a “front-back direction (FB direction)”, a “left-right direction (RL direction)”, an “up-down direction (UD direction)”, “front (F)”, “back (B)”, “left (L)”, “right (R)”, “up (U)”, and “down (D)” are defined for convenience of description. The “front-back direction”, the “left-right direction”, and the “up-down direction” are orthogonal to one another.

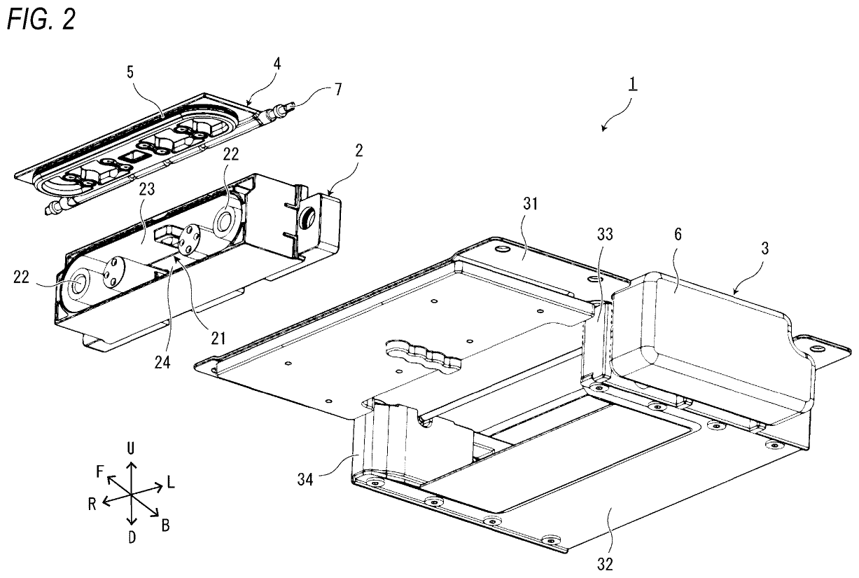

An inlet plug (not shown), which is a mating connector, is fitted into an inlet 1, which is a connector according to the present embodiment. As shown in FIGS. 1 and 2, the inlet 1 includes a housing 2 that accommodates connection terminals, an outer case 3 that accommodates and holds the housing 2, a cover 4 that covers a front opening 21 of the housing 2 in an openable and closable manner, and an annular packing 5 that seals a gap between the cover 4 and the housing 2.

The housing 2 of the inlet 1 is molded from an electrically insulating synthetic resin. The housing 2 includes a pair of accommodating portions 22, 22 that respectively accommodate the connection terminals connected to end portions of high-voltage cables (not shown), and a tubular portion 23 having the front opening 21 into which the inlet plug is to be inserted.

In the present specification, a rearward direction is an insertion direction in which the inlet plug is inserted, and a forward direction is a direction opposite to the insertion direction.

The pair of accommodating portions 22, 22 protrude forward from a front wall portion 24 orthogonal to (intersecting) the front-back direction. The front wall portion 24 is elongated in the left-right direction, and the pair of accommodating portions 22, 22 are arranged side by side in the left-right direction. The tubular portion 23 protrudes forward from the front wall portion 24. The tubular portion 23 has an oval shape elongated in the left-right direction when viewed from a front side, and continuously surrounds the pair of accommodating portions 22, 22 without interruption. The tubular portion 23 has the front opening 21 into which the inlet plug is to be inserted.

The outer case 3 is a flat housing including a top plate 31 that covers an upper side of the housing 2, a bottom plate 32 that covers a lower side of the housing 2, a left side portion 33 that covers a left side surface of the housing 2, and a right side portion 34 that covers a right side surface of the housing 2, with both sides in the front-back direction open. The left side portion 33 and the right side portion 34 rotatably support both ends of a rotating shaft 7 of the cover 4. A motor 6 is attached to the left side portion 33. The motor 6 rotates the cover 4 by applying a driving force to the rotating shaft 7.

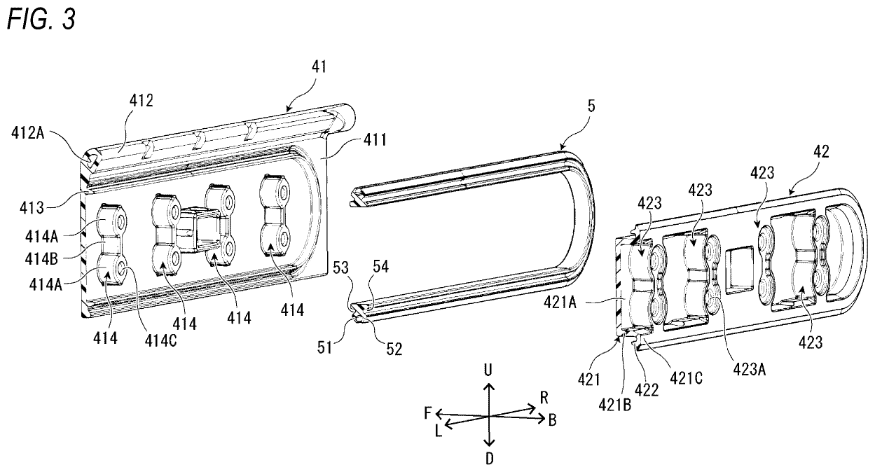

The cover 4 is made of an electrically insulating synthetic resin. As shown in FIG. 3, the cover 4 includes a front cover 41 as a first member and a rear cover 42 as a second member. The front cover 41 is disposed in front of the rear cover 42 at a closed position where the front opening 21 is closed. The rear cover 42 is disposed behind the front cover 41 at the closed position. The front cover 41 and the rear cover 42 are separately provided to sandwich and hold the packing 5 therebetween.

The front cover 41 includes a front cover body 411 serving as a first body that covers the front opening 21, a rotating shaft portion 412, a first protrusion 413 annularly protruding from the front cover body 411, and first fixing portions 414 for fixing the rear cover 42 to be described later. The front cover body 411 has a substantially rectangular plate shape elongated in the left-right direction. The rotating shaft portion 412 is provided at an upper end of the front cover body 411 at the closed position, and is provided along the left-right direction.

In the present embodiment, the rotating shaft portion 412 has a tubular shape, and has, therein, an insertion hole 412A into which the metal rotating shaft 7 (see FIG. 2) is to be inserted. As shown in FIG. 2, the rotating shaft 7 protrudes from both left and right ends of the rotating shaft portion 412, and both ends thereof are rotatably supported by the outer case 3. The metal rotating shaft 7 inserted into the rotating shaft portion 412 of the front cover 41 is rotatably supported by the outer case 3 in the present embodiment, but present invention is not limited thereto. The rotating shaft portion 412 of the front cover 41 may be rotatably supported by the outer case 3.

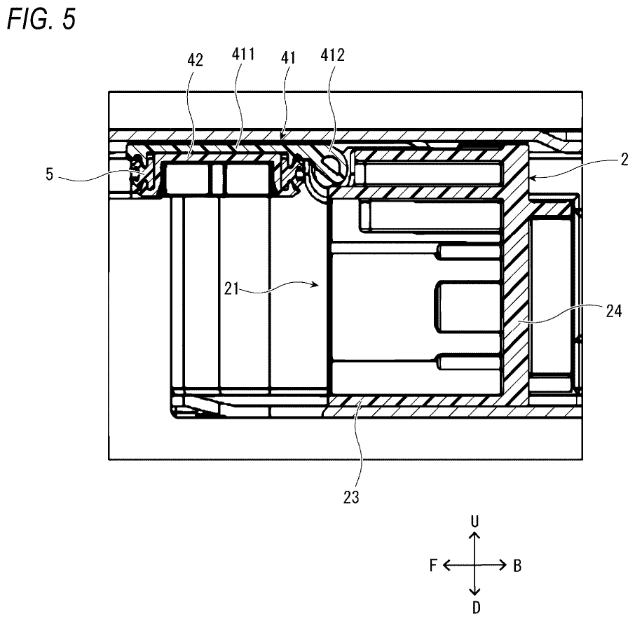

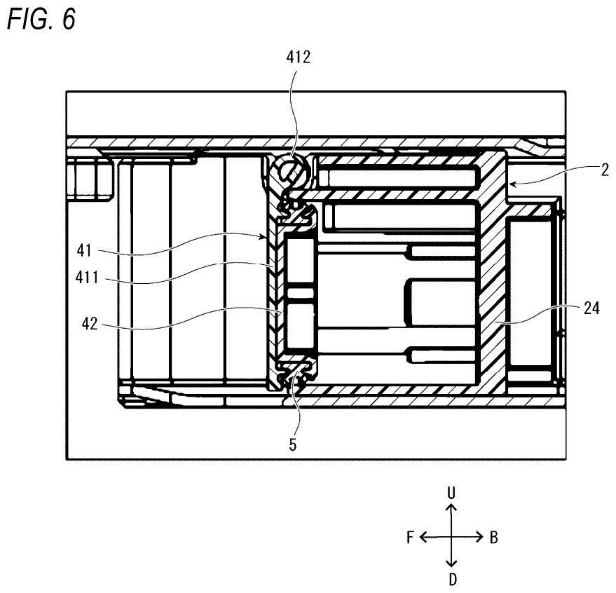

The cover 4 rotates about the rotating shaft portion 412 between an open position (FIG. 5) and the closed position (FIG. 6). The open position is a position where the front cover body 411 is perpendicular to the up-down direction and the front opening 21 is open. The closed position is a position where the front cover body 411 is perpendicular to the front-back direction and the front opening 21 is closed.

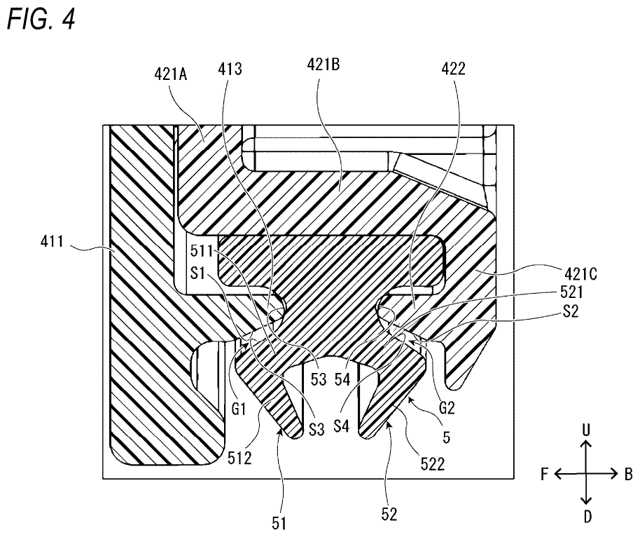

As shown in FIGS. 3 and 4, the first protrusion 413 has a substantially oval annular shape elongated in the left-right direction along the inside of the tubular portion 23. The first protrusion 413 protrudes rearward from the front cover body 411 at the closed position. As shown in FIG. 3, the first fixing portions 414 protrude from a portion of the front cover body 411 surrounded by the first protrusion 413.

In the present embodiment, four first fixing portions 414 are arranged side by side in the left-right direction. Each of the first fixing portions 414 includes a pair of bosses 414A, 414A and a rib 414B connecting the pair of bosses 414A, 414A. The pair of bosses 414A, 414A are arranged side by side in the up-down direction, and each have a screw hole 414C that is screwed with a screw. The rib 414B connects an upper end and a lower end of the pair of bosses 414A, 414A arranged side by side in the up-down direction, and is elongated in the up-down direction.

The rear cover 42 includes a rear cover body 421, a second protrusion 422 annularly protruding from the rear cover body 421, and second fixing portions 423 for fixing the front cover 41. The rear cover body 421 includes a wall portion 421A facing, in the front-back direction, the portion of the front cover body 411 surrounded by the first protrusion 413, a side wall portion 421B standing rearward from an edge portion of the wall portion 421A, and a flange portion 421C protruding outward from a rear end of the side wall portion 421B.

The wall portion 421A has an oval shape slightly smaller than the portion of the front cover body 411 surrounded by the first protrusion 413. The side wall portion 421B stands from the entire peripheral edge of the wall portion 421A and has an annular shape. As shown in FIG. 4, the side wall portion 421B is disposed inside the annular first protrusion 413 at an interval from the first protrusion 413, and the rear end of the side wall portion 421B protrudes further rearward than a tip end of the first protrusion 413. The flange portion 421C protrudes outward from the entire rear end of the side wall portion 421B and covers a rear side of the first protrusion 413. The second protrusion 422 protrudes forward from the flange portion 421C. The second protrusion 422 faces the first protrusion 413 at an interval in the front-back direction, and has a substantially oval annular shape.

As shown in FIG. 3, the second fixing portions 423 protrude rearward from the wall portion 421A. A recess into which the first fixing portion 414 is fitted is formed on a front side of the second fixing portion 423. The second fixing portion 423 has a screw through hole 423A through which a screw is to be inserted.

The packing 5 is made of an elastic member such as rubber. The packing 5 has an oval annular shape elongated in the left-right direction. The side wall portion 421B of the rear cover 42 is press-fitted into the packing 5. That is, as shown in FIG. 4, a flat inner surface of the packing 5 and an outer surface of the side wall portion 421B of the rear cover 42 overlap each other. An outer surface of the packing 5 serves as a contact surface that comes into contact with an inner surface of the tubular portion 23 at the closed position. In the present embodiment, the outer surface of the packing 5 includes a first lip portion 51 and a second lip portion 52 protruding side by side along a central axis direction of the packing 5. The first lip portion 51 and the second lip portion 52 are provided over the entire periphery of the packing 5. The first lip portion 51 and the second lip portion 52 will be described later.

In this specification, the central axis direction of the packing 5 is along the front-back direction at the closed position and along the up-down direction at the open position.

The packing 5 has a first recess 53 formed in a surface on one side in the central axis direction (front side in FIG. 3) and a second recess 54 formed in a surface on the other side in the central axis direction (rear side in FIG. 3). The first recess 53 and the second recess 54 are formed over the entire periphery of the packing 5. The first protrusion 413 of the front cover 41 is inserted into the first recess 53, and the second protrusion 422 of the rear cover 42 is inserted into the second recess 54. Accordingly, the packing 5 is sandwiched and held between the front cover 41 and the rear cover 42 in the central axis direction.

Next, detailed configurations of the first protrusion 413, the second protrusion 422, the first recess 53, and the second recess 54 will be described. As shown in FIG. 4, gaps G1, G2 are formed between the packing 5 and side surfaces S1, S2 of the first protrusion 413 and the second protrusion 422 closer to the first lip portion 51 and the second lip portion 52 than top portions of the first protrusion 413 and the second protrusion 422. In the present embodiment, the gaps G1, G2 are formed when the cover 4 is at both the open position and the closed position, but the gaps G1, G2 may be formed when the cover 4 is at least at the open position.

The side surfaces S1, S2 of the first protrusion 413 and the second protrusion 422 closer to the first lip portion 51 and the second lip portion 52 than the top portions of the first protrusion 413 and the second protrusion 422 are respectively provided on first inclined surfaces that are away from tip ends of the first lip portion 51 and the second lip portion 52 as approaching each other. Side surfaces S3, S4 (surfaces facing the side surfaces S1, S2) of the first recess 53 and the second recess 54 closer to the first lip portion 51 and the second lip portion 52 than bottom portions of the first recess 53 and the second recess 54 are respectively provided on second inclined surfaces that are away from the tip ends of the first lip portion 51 and the second lip portion 52 as approaching each other. Slopes of the second inclined surfaces provided with the side surfaces S3, S4 are larger than slopes of the first inclined surfaces provided with the side surfaces S1, S2. Therefore, when the cover 4 is at the open position, the gaps G1, G2 can be formed between the first inclined surfaces (side surfaces S1, S2) and the second inclined surfaces (side surfaces S3, S4).

Next, the first lip portion 51 and the second lip portion 52 will be described in detail. The first lip portion 51 and the second lip portion 52 protrude outward from the outer surface of the packing 5, and are arranged side by side along the central axis direction (front-back direction in FIG. 3). The first lip portion 51 and the second lip portion 52 include first inclined portions 511, 521 that are inclined along the second inclined surfaces of the side surfaces S3, S4, and second inclined portions 512, 522 that are continuous with tip end sides of the first inclined portions 511, 521 and approach each other toward the tip ends.

Next, assembly of the connector 1 will be described. First, the side wall portion 421B of the rear cover 42 is press-fitted into the inner surface of the packing 5 to attach the packing 5 to the rear cover 42. At this time, the second protrusion 422 is inserted into the second recess 54 of the packing 5. Next, the front cover 41 is stacked in front of the rear cover 42 attached with the packing 5. At this time, the first protrusion 413 of the front cover 41 is inserted into the first recess 53 of the packing 5. The first fixing portion 414 is fitted into the second fixing portion 423. Thereafter, a screw is inserted into the screw through hole 423A of the second fixing portion 423 and then screwed into the screw hole 414C of the first fixing portion 414. Accordingly, the cover 4 is completed. Thereafter, the housing 2 is accommodated in the outer case 3, and the cover 4 is attached to the outer case 3 to complete the process.

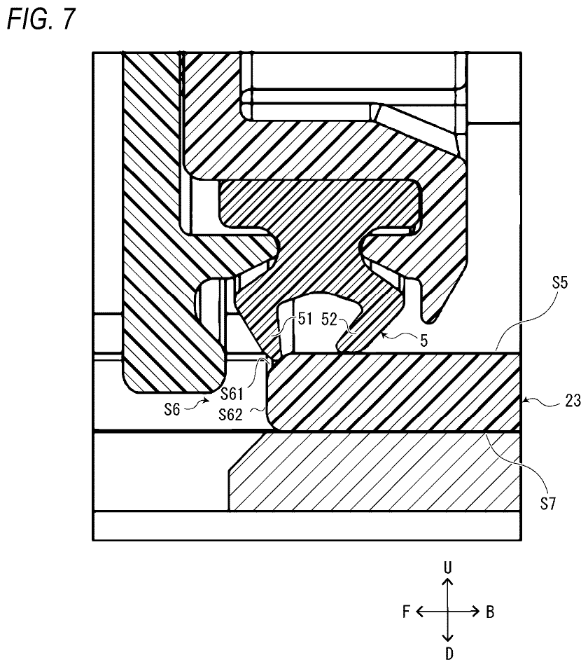

When the connector 1 is not to be fitted to the inlet plug, the motor 6 rotates the cover 4 from the open position (FIG. 5) to the closed position (FIG. 6). Accordingly, the front opening 21 is closed by the cover 4. Specifically, when rotating the cover 4 to the closed position, the second lip portion 52 first reaches an inner surface S5 (see FIG. 7) of the tubular portion 23, and the tip end of the second lip portion 52 moves rearward while being in sliding-contact with the inner surface S7 of the tubular portion 23. At this time, the second lip portion 5 is deformed such that the gap G2 becomes smaller and an angle formed by the first inclined portion 521 and the second inclined portion 522 becomes smaller.

When further rotating the cover 4, as shown in FIG. 7, the cover 4 moves to the closed position where the tip end of the first lip portion 51 comes into contact with an end surface S6 of the tubular portion 23, and a space between the cover 4 and the tubular portion 23 is sealed by the packing 5. More specifically, the end surface S6 of the tubular portion 23 includes an inclined surface S61 that is continuous with the inner surface S5 of the tubular portion 23 and has a slope that approaches an outer surface S7 of the tubular portion 23 as the slope goes forward, and an orthogonal surface S62 that is continuous with the inclined surface S61 and is orthogonal to the front-back direction. The first lip portion 51 comes into contact with the inclined surface S5 of the end surface S6.

When fitting to the inlet plug, the motor 6 rotates the cover 4 to the open position. Accordingly, the front opening 21 is open, and the inlet plug can be inserted into the tubular portion 23.

According to the embodiment described above, the packing 5 has the first recess 53 formed in the surface on the one side in the central axis direction of the annular shape (front side in FIG. 3), and the second recess 54 formed in the surface on the other side in the central axis direction (rear side in FIG. 3). The cover 4 to which the packing 5 is to be attached includes the front cover 41 and the rear cover 42 that are separately provided to sandwich and hold the packing 5 therebetween. The front cover 41 includes the first protrusion 413 to be inserted into and held by the first recess 53, and the rear cover 42 includes the second protrusion 422 to be inserted into and held by the second recess 54. Accordingly, the packing 5 is sandwiched and firmly held between the front cover 41 and the rear cover 42. Therefore, when rotating the cover 4 to the closed position, even if the packing 5 is in sliding-contact with the inner surface of the tubular portion 23, it is possible to prevent an assembly failure of the packing 5 such as biting or coming-off of the packing 5.

According to the embodiment described above, the packing 5 is attached to the cover 4. Accordingly, the packing 5 does not become an obstacle when inserting the inlet plug into the tubular portion 23.

According to the embodiment described above, the front cover 41 includes the rotating shaft portion 412 and the front cover body 411 that covers the front opening 21, and the first protrusion 413 annularly protrudes from the front cover body 411. The rear cover 42 includes the rear cover body 421 that faces the front cover body 411 in the central axis direction (front-back direction in FIG. 3), and the second protrusion 422 annularly protrudes from the rear cover body 421. Accordingly, the first protrusion 413 can be provided on the front cover 41 and the second protrusion 422 can be provided on the rear cover 42 with a simple configuration.

According to the embodiment described above, when the cover 4 is at the open position, the gaps G1, G2 are formed between the packing 5, and the first protrusion 413 the second protrusion 422. Accordingly, when the packing 5 is in sliding-contact with the inner surface of the tubular portion 23, the packing 5 is easily deformed in a direction in which the gaps G1, G2 become smaller. Therefore, a force with which tip end surfaces (contact surfaces) of the first lip portion 51 and the second lip portion 52 press the inner surface of the tubular portion 23 is reduced, and an insertion force when inserting the packing 5 into the tubular portion 23 can be reduced.

According to the embodiment described above, the first lip portion 51 and the second lip portion 52 arranged side by side in the central axis direction are provided on the contact surface of the packing 5. Accordingly, since both the first lip portion 51 and the second lip portion 52 can function in sealing, waterproofness and dustproof property in the tubular portion 23 can be further improved.

According to the embodiment described above, the side surfaces S1, S2 of the first protrusion 413 and the second protrusion 422 are provided on the first inclined surfaces that are away from the contact surfaces (tip ends of the first lip portion 51 and the second lip portion 52) as approaching each other. The side surfaces S3, S4, facing the side surfaces S1, S2 of the first protrusion 413 and the second protrusion 422, of the first recess 53 and the second recess 54 are provided on the second inclined surfaces that are away from the contact surfaces (tip ends of the first lip portion 51 and the second lip portion 52) as approaching each other. The first lip portion 51 and the second lip portion 52 include the first inclined portions 511, 521 that are inclined along the second inclined surfaces, and the second inclined portions 512, 522 that are continuous with tip ends of the first inclined portions 511, 521 and approach each other toward the tip ends.

Accordingly, the second lip portion 52 having a larger amount of sliding-contact with the tubular portion 23 than the first lip portion 51 can have a shape in which the tip end is less likely to be caught when being in sliding-contact with the inner surface S5 of the tubular portion 23, and the insertion force can be further reduced. When the cover 4 is at the closed position, even if water or dust enters beyond the first lip portion 51, the water or dust is returned toward the first lip portion 51 along the first inclined portion 521 and the second inclined portion 522 of the second lip portion 52, and thus the waterproofness and dustproof property can be further improved.

The present invention is not limited to the embodiment described above, and can be appropriately modified, improved, or the like. In addition, materials, shapes, sizes, numbers, arrangement positions and the like of components in the embodiment described above are freely selected and are not limited as long as the present invention can be implemented.

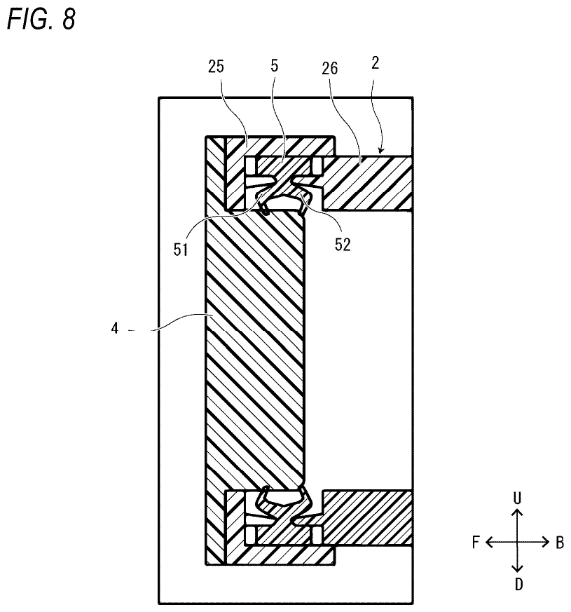

The packing 5 is attached to the cover 4 in the embodiment described above, but present invention is not limited thereto. As shown in FIG. 8, the housing 2 may include two components, namely a front housing 25 and a rear housing 26, and the packing 5 may be sandwiched and held between the front housing 25 and the rear housing 26.

In this case, the first and second lip portions 51, 52 also include the first inclined portions 511, 521 and the second inclined portions 512, 522. Accordingly, similarly to the embodiment described above, the first lip portion 51 having a larger amount of sliding-contact with the cover 4 than the second lip portion 52 can have a shape in which a tip end is less likely to be caught, and an insertion force when moving the cover 4 to a closed position can be reduced.

The packing 5 includes both the first lip portion 51 and the second lip portion 52 according to the embodiment described above, but the present invention is not limited thereto. The packing 5 may not include the first lip portion 51 and the second lip portion 52.

The gaps G1, G2 are formed between the packing 5 and the side surfaces S1, S2 of the first protrusion 413 and the second protrusion 422 according to the embodiment described above, but the present invention is not limited thereto. The gaps G1, G2 may be not be formed. The first lip portion 51 and the second lip portion 52 include the first inclined portions 511, 521 and the second inclined portions 512, 522 according to the embodiment described above, but the present invention is not limited thereto. The first lip portion 51 and the second lip portion 52 may simply protrude toward the inner surface of the tubular portion 23.

Here, features of the connector according to the embodiment of the present invention described above are briefly summarized and listed in the following [1] to [6].
[1] A connector (1) includes:
a housing (2) including an accommodating portion (22) that accommodates a connection terminal and a tubular portion (23) having an opening (21) into which a mating connector is to be inserted;
a cover (4) configured to cover the opening (21) in an openable and closable manner; and
an annular packing (5) configured to be attached to one of the cover (4) and the housing (2) and to seal a gap between the tubular portion (23) and the cover (4) at a closed position where the cover (4) closes the opening (21), in which
the packing (5) has a first recess (53) formed in a surface on one side (front side at the closed position) in a central axis direction of an annular shape, and a second recess (54) formed in a surface on the other side in the central axis direction (rear side at the closed position),
the one of the cover (4) and the housing (2) to which the packing (5) is to be attached includes a first member (41) and a second member (42) that are separately provided to sandwich and hold the packing (5) therebetween,
the first member (41) includes a first protrusion (413) to be inserted into and held by the first recess (53), and
the second member (42) includes a second protrusion (422) to be inserted into and held by the second recess (54).

According to a configuration of [1], the packing (5) is sandwiched and firmly held between the first member (41) and the second member (42). Therefore, when moving the cover (4) to the closed position, even if the packing (5) is in sliding-contact with the other of the cover (4) and the housing (2), it is possible to prevent an assembly failure of the packing (5) such as biting or coming-off of the packing (5).
[2] In the connector according to [1], the packing is attached to the cover.

According to a configuration of [2], the packing (5) does not become an obstacle when inserting the mating connector into the tubular portion (23).
[3] In the connector (1) according to [2],
the first member (41) of the cover (4) includes a rotating shaft portion (412) and a first body (411) that covers the opening (21),
the first protrusion (413) annularly protrudes from the first body (411),
the second member (42) of the cover (4) includes a second body (421) fixedly disposed at a position facing the first body (411) in the central axis direction (front-back direction at the closed position), and
the second protrusion (422) annularly protrudes from the second body (421).

According to a configuration of [3], the first protrusion (413) can be provided on the first member (41) and the second protrusion (422) can be provided on the second member (42) with a simple configuration.
[4] In the connector (1) according to any one of [1] to [3],
the packing (5) has a contact surface, namely one of an inner surface and an outer surface, which comes into contact with the other of the cover (4) and the housing (2) at the closed position, and
gaps (G1, G2) are formed between the packing (5) and side surfaces (S1, S2) of the first protrusion (413) and the second protrusion (422) on a contact surface side at an open position where the cover (4) is open.

According to a configuration of [4], when moving the cover (4) to the closed position and the packing (5) is in sliding-contact with the other of the cover (4) and the housing (2), the packing (5) is easily deformed in a direction in which the gap (G1, G2) becomes smaller. Therefore, a force with which the contact surface of the packing (5) presses the other of the cover (4) and the housing (2) is reduced, and an insertion force when inserting the packing (5) into the other of the cover (4) and the housing (2) can be reduced.
[5] In the connector (1) according to [4],
the packing (5) includes a first lip portion (51) and a second lip portion (52) arranged side by side in the central axis direction (front-back direction at the closed position), and
each of tip ends of the first lip portion (51) and the second lip portion (52) serves as the contact surface.

According to the configuration of [5], since both the first lip portion (51) and the second lip portion (52) can function in sealing, waterproofness and dustproof property in the housing (2) can be further improved.
[6] In the connector (1) according to [5],
the side surfaces (S1, S2) of the first protrusion (413) and the second protrusion (422) are respectively provided on first inclined surfaces that are away from the tip ends of the first lip portion (51) and the second lip portion (52) as approaching each other,
surfaces (S3, S4), facing the side surfaces (S1, S2) of the first protrusion (413) and the second protrusion (422), of the first recess (53) and the second recess (54) are respectively provided on second inclined surfaces that are away from the tip ends of the first lip portion (51) and the second lip portion (52) as approaching each other, and
the first lip portion (51) and the second lip portion (52) include first inclined portions (511, 521) that are inclined along the second inclined surfaces, and second inclined portions (512, 522) that are continuous with tip end sides of the first inclined portions (511, 521) and approach each other toward the tip ends.

According to a configuration of [6], one of the first lip portion (51) and the second lip portion (52) (the second lip portion (52) in the example shown in FIG. 7, and the first lip portion (51) in the example shown in FIG. 8) having a larger amount of sliding-contact with the other of the cover (4) and the housing (2) can have a shape in which the tip end is less likely to be caught, and an insertion force can be reduced. When the cover (4) is at the closed position, even if water or dust enters beyond the first lip portion (51), the water or dust is returned toward the first lip portion (51) along the first inclined portion (521) and the second inclined portion (522) of the second lip portion (52), and thus the waterproofness and dustproof property can be further improved.

Although the present invention has been described in detail with reference to the specific embodiments, it is apparent to those skilled in the art that various changes and modifications can be made without departing from the spirit and scope of the present invention.

The present application is based on a Japanese patent application (Japanese Patent Application No. 2022-025076) filed on Feb. 21, 2022, contents of which are incorporated herein by reference.

### INDUSTRIAL APPLICABILITY

According to the present invention, it is possible to provide the connector that prevents the assembly failure of the packing. The present invention having this effect is useful for connectors.

### REFERENCE SIGNS LIST

1: inlet (connector)
2: housing
4: cover
5: packing
21: front opening (opening)
22: accommodating portion
23: tubular portion
41: front cover (first member)
42: rear cover (second member)
51: first lip portion
52: second lip portion
53: first recess
54: second recess
411: front cover body (first body)
412: rotating shaft portion
413: first protrusion
421: rear cover body (second body)
422: second protrusion
511, 521: first inclined portion
512, 522: second inclined portion
S1, S2: side surface
S3, S4: side surface (surface)
G1, G2: gap

1. A connector comprising:
a housing including an accommodating portion that accommodates a connection terminal and a tubular portion having an opening into which a mating connector is to be inserted;
a cover configured to cover the opening in an openable and closable manner; and
an annular packing configured to be attached to one of the cover and the housing and to seal a gap between the tubular portion and the cover at a closed position where the cover closes the opening, wherein:
the packing has a first recess formed in a surface on one side in a central axis direction of an annular shape, and a second recess formed in a surface on the other side in the central axis direction;
the one of the cover and the housing to which the packing is to be attached includes a first member and a second member that are separately provided to sandwich and hold the packing therebetween;
the first member includes a first protrusion to be inserted into and held by the first recess;
the second member includes a second protrusion to be inserted into and held by the second recess;
the packing has a contact surface, namely one of an inner surface and an outer surface; which comes into contact with the other of the cover and the housing at the closed position; and
gaps are formed between the packing and side surfaces of the first protrusion and the second protrusion on a contact surface side at an open position where the cover is open.

2. The connector according to claim 1, wherein
the packing is attached to the cover.

3. The connector according to claim 2, wherein:
the first member of the cover includes a rotating shaft portion and a first body that covers the opening;
the first protrusion annularly protrudes from the first body;
the second member of the cover includes a second body fixedly disposed at a position facing the first body in the central axis direction; and
the second protrusion annularly protrudes from the second body.

4. The connector according to claim 1, wherein:
the packing includes a first lip portion and a second lip portion arranged side by side in the central axis direction; and
each of tip ends of the first lip portion and the second lip portion serves as the contact surface.

5. The connector according to claim 4, wherein:
the side surfaces of the first protrusion and the second protrusion are respectively provided on first inclined surfaces that are away from the tip ends of the first lip portion and the second lip portion as approaching each other;
surfaces, facing the side surfaces of the first protrusion and the second protrusion, of the first recess and the second recess are respectively provided on second inclined surfaces that are away from the tip ends of the first lip portion and the second lip portion as approaching each other; and
the first lip portion and the second lip portion include first inclined portions that are inclined along the second inclined surfaces, and second inclined portions that are continuous with tip end sides of the first inclined portions and approach each other toward the tip ends.
